(19) United States
(12) Patent Application Publication
(10) Pub. No.: US 2009/0080876 A1
(43) Pub. Date: Mar. 26, 2009

(54) Method For Distance Estimation Using AutoFocus Image Sensors And An Image Capture Device Employing The Same

(76) Inventors: Mikhail Brusnitsyn, North York (CA); Angus Harry Mansell McQuarrie, Richmond Hill (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/861,026

(22) Filed: Sep. 25, 2007

(51) Int. Cl. G03B 13/20

(52) U.S. Cl. 396/128; 382/106

(57) ABSTRACT

A method of estimating the distance to a subject using image signals generated by autofocus image sensors of an image capture device comprises processing image data of each image sensor to detect edges therein and for each image sensor generating a corresponding edge image, correlating the edge images to determine the shift of one edge image relative to the other edge image that yields the best match therebetween, and calculating a distance estimation based at least on the determined shift.

### FIELD OF THE INVENTION

The present invention relates generally to distance estimation and in particular, to a method for distance estimation using autofocus image sensors and an image capture device employing the same.

### BACKGROUND OF THE INVENTION

Most modern image capture devices such as cameras, video recorders, camcorders etc. include a suite of automatic features that work together to enable an operator to capture images as easily as possible. The autofocus (AF) feature is one very common feature in this suite. The AF feature in a camera makes use of a processor in the camera to run a small motor that focuses the camera lens automatically by moving the lens either in or out until the sharpest possible image is obtained.

Cameras with the AF feature typically employ one of two types of autofocus systems, namely passive autofocus systems and active autofocus systems, although some cameras employ a combination of both passive and active autofocus systems. Less expensive point-and-shoot cameras usually employ active AF systems while more expensive single-lens reflex (SLR) cameras employ passive AF systems.

A typical active AF system comprises an infrared emitter that emits an infrared signal and an infrared receiver that detects the reflected infrared signal returning to the camera. The camera processor computes the elapsed time between transmission of the infrared signal by the emitter and detection of the reflected infrared signal by the receiver. The computed elapsed time is then used by the camera processor to run the motor to adjust the lens position to correct focus automatically.

Two types of passive AF systems are common, namely contrast measurement AF systems and phase detection AF systems. In a contrast measurement AF system, a charge-coupled device (CCD) looking through the camera lens is used to capture an image of a strip. The captured strip image is conveyed to the camera processor which in turn examines the intensities of adjacent pixels in the strip image. If adjacent pixels in the strip image have similar intensities, the strip image is deemed to be out of focus. The processor in turn runs the motor to adjust the camera lens position and the above process is repeated until the camera lens is at a position that results in the maximum intensity difference between adjacent pixels.

In a phase detection AF system, the light entering the camera lens is divided and directed onto right and left linear image sensors 10 and 12 via associated lenses 14 and 16 respectively, as shown in FIG. 1. Although not shown, the right and left image sensors 10 and 12 are angled inwardly so as to look down the optical axis OA of the sensor assembly. The output of the image sensors 10 and 12 yield image signals that are compared by the camera processor and analyzed for similar light intensity patterns. The phase difference between the image signals is then calculated to determine if the subject is in a front focus position or a back focus position. The phase difference thus provides the position of the camera lens to achieve focus allowing the camera processor to run the motor so that the camera lens moves to that position.

The phase detection AF system shown in FIG. 1 can also be used to estimate the distance of a subject from the camera as the difference between image signals output by the image sensors 10 and 12 is dependent on the distance of the subject from the camera. In order to estimate the distance it is necessary to correlate the image signals output by the image sensors 10 and 12 and find the best match between them. In an ideal environment, the direct approach, which involves comparing the image signals output by the image sensors 10 and 12 to each other and determining the shift between the two image signals where the difference between them is a minimum, yields a satisfactory result. Unfortunately, due to imperfect light insulation in the camera and/or ambient light, the image signals output by the image sensors 10 and 12 are often displaced relative to one another as shown in FIG. 2. In addition, the phase detection AF system often develops periodic noise that makes the image signal from even elements of each image sensor higher or lower than the image signal from odd elements of the image sensor as shown in FIG. 3. As can be seen, this periodic noise, commonly referred to as parity noise, alternates from high to low for consecutive elements of the image sensor.

As capturing in-focus images is critical to camera users, it is of no surprise that significant effort has been expended in the field of AF systems and many variations of AF systems have been considered. For example, U.S. Pat. No. 5,142,357 to Lipton et al. discloses an electronic stereoscopic video camera for capture and playback of still or moving images. The video camera employs signal processing means to process the video output of left and right image sensors in order to locate the positions of left and right images in the video camera's left and right image fields, respectively. Through comparison of the located left and right images, control signals are generated for adjusting the effective position of one or both of the image sensors in relation to a set of fixedly mounted camera lenses.

U.S. Pat. No. 5,293,194 to Akashi discloses a focus detection apparatus for a camera in which a plurality of focus sensors detect the focus state of a plurality of different areas within a scene. A processor determines whether focus can or cannot be obtained for a specific area of the scene on the basis of the outputs of the focus sensors. An auxiliary light is emitted to assist in focusing, if the specific area of the scene is, for example, the central area of the scene.

U.S. Pat. No. 5,369,430 to Kitamura discloses a focus detecting method and apparatus. During the method, the real image of an object including a plurality of object patterns is projected onto an image pickup device through an optical system and resulting image data from the image pickup device is produced. Correlation values of the image data of each of the plurality of object patterns and the image data of a prestored reference pattern are calculated while varying the relative positional relation among the image pickup device, the optical system and the object in the direction of the optical axis of the optical system. The relative positional relation yielding the maximum correlation value is deemed to result in an in-focus state.

U.S. Pat. No. 6,707,937 to Sobel et al. discloses a method and apparatus for interpolating color image information in a digital image. Image data values for a portion of the digital image in the vicinity of a target pixel are received and stored in a local array. A processor determines whether there is an edge in the vicinity of the target pixel based on the data values in the local array. If there is no edge in the vicinity of the target pixel, then long scale interpolation is performed on the image data values in the local array in order to generate color information that is missing from the image. If there is an edge in the vicinity of the target pixel, then short scale interpolation is performed using image data values in a subset of the local array that is in close vicinity of the target pixel.

U.S. Pat. No. 6,785,496 and U.S. Patent Application Publication No. 2005/0013601 to Ide et al. disclose a distance-measuring device having an AF area sensor that includes an image pick up element formed on a semiconductor substrate for receiving two images having a parallax between them and a photo reception signal processing circuit formed on the semiconductor substrate for processing signals corresponding to light received by the image pick up element. On the basis of sensor data obtained by integration executed in the AF area sensor in an outline detection mode, the distance-measuring device detects a main subject in a photography screen, sets a distance-measuring area including the main subject, and measures the distance to the main subject.

U.S. Patent Application Publication No. 2002/0114015 to Fujii et al. discloses an AF control portion of a digital camera having a histogram generating circuit that generates a histogram of widths of edges in an AF area and a noise eliminating portion that eliminates noise components from the histogram. A histogram evaluating portion calculates an evaluation value indicative of the degree of achieving focus from the histogram and a contrast calculating circuit calculates contrast in the AF area. A driving direction determining portion determines the required driving direction of the focusing lens to achieve using the contrast. A driving amount determining portion positions the focusing lens to an in-focus position using the evaluation value of the histogram and the contrast.

U.S. Patent Application Publication No. 2003/0118245 to Yaroslavsky discloses an apparatus and method of automatically focusing an imaging system employing one or both of an edge detection approach and an image comparison approach. The edge detection approach comprises computing an edge density for each image of a set of images of the object, and selecting the focus position that corresponds to the image of the set having the greatest computed edge density as the optimum focus position. The image comparison approach comprises adjusting the focus position based on the difference between focus positions for a reference image and a closely matched image of a typical object.

U.S. Patent Application Publication No. 2006/0029284 to Stewart discloses a method of determining a focus measure from an image. During the method, one or more edges in the image is detected by processing the image with one or more first order edge detection kernels adapted to reject edge phasing effects. A first strength measure of each of the edges and the contrast of each of the edges are determined. The first strength measure of each of the edges is normalized by the contrast of each of the edges to obtain a second strength measure of each of the edges. One or more of the edges from the image is selected in accordance with the second strength measure and the focus measure is calculated using the second strength measure of the selected edges.

U.S. Patent Application Publication No. 2006/0062484 to Aas et al. discloses a method comprising detecting edges in at least a region of a captured focus image using adjacent pixels of the region to obtain first edge detection results and filtering the first edge detection results. The filtering comprises comparing differences in pixel contrast in the first edge detection results with a first threshold value and removing the differences in pixel contrast that are less than the first threshold value from the first edge detection results. Edges in at least the region are detected using non-adjacent pixels of the region to obtain second edge detection results and the second edge detection results are filtered. The second filtering comprises comparing differences in pixel contrast in the second edge detection results with a second threshold value and removing the differences in pixel contrast that are less than the second threshold value from the second edge detection results.

Although the references described above discuss different autofocus techniques, improvements are desired. It is therefore an object of the present invention to provide a novel method for distance estimation using autofocus image sensors and an image capture device employing the same.

### SUMMARY OF THE INVENTION

Accordingly, in one aspect there is provided a method of estimating the distance to a subject using image signals generated by autofocus image sensors of an image capture device, said method comprising:

processing image data of each image sensor to detect edges therein and for each image sensor generating a corresponding edge image;

correlating the edge images to determine the shift of one edge image relative to the other edge image that yields the best match therebetween; and

calculating a distance estimation based at least on the determined shift.

In one embodiment, prior to the calculating, the determined shift is adjusted based on correlation data generated during the correlating to enable the distance estimation to be calculated to sub-pixel accuracy. During the correlating, the one edge image is compared with the other edge image and a cross-correlation value is generated. The one edge image is then shifted relative to the other edge image and another cross-correlation value is generated. After this process has been repeated over a plurality of shifts, the smallest cross-correlation value is determined. The shift position associated with the smallest cross-correlation value is selected as the determined shift. If desired, prior to the correlating, the size of the edge images can be doubled.

According to another aspect there is provided an apparatus for estimating the distance to a subject using image signals generated by autofocus image sensors of said image capture device, said apparatus comprising:

processing structure communicating with said image sensors, said processing structure processing image data of each image sensor to detect edges therein and for each image sensor generating a corresponding edge image, correlating the edge images to determine the shift of one edge image relative to the other edge image that yields the best match therebetween and calculating a distance estimation based on the determined shift and at least one parameter of said image capture device.

According to still yet another aspect there is provided a computer readable medium embodying a computer program for estimating the distance to a subject using image signals generated by autofocus image sensors of an image capture device, said computer program comprising:

computer program code for processing image data of each image sensor to detect edges therein and for each image sensor generating a corresponding edge image;

computer program code for correlating the edge images to determine the shift of one edge image relative to the other edge image that yields the best match therebetween; and

computer program code for calculating a distance estimation based at least on the determined shift.

### BRIEF DESCRIPTION OF THE DRAWINGS

Embodiments will now be described more fully with reference to the accompanying drawings in which:

FIG. 1 shows right and left image sensors of a conventional phase detection autofocus (AF) system;

FIG. 2 shows displacement between image data output by the right and left image sensors of FIG. 1;

FIG. 3 shows parity noise in the image data of FIG. 2;

FIG. 4 is a simplified schematic diagram of a digital camera employing a phase detection AF system;

FIG. 5 is a flowchart showing the steps performed by the digital camera of FIG. 4 during distance estimation using the phase detection AF system;

FIG. 6 shows raw image data and corresponding edge data;

FIG. 7 shows a correlation window centered on a left edge image and a sliding correlation window at the two extremes of its shift range; and

FIG. 8 shows an example of 3-point linear interpolation.

### DETAILED DESCRIPTION OF THE EMBODIMENTS

In the following description, an embodiment of a distance estimation method using autofocus image sensors and an image capture device employing the same is provided. During the method, image data of each autofocus image sensor is processed to detect edges therein and for each image sensor, a corresponding edge image is generated. The edge images are correlated to determine the shift of one edge image relative to the other edge image that yields the best match therebetween i.e. the minimum difference between the edge images. A distance estimation is then calculated based at least on the determined shift. If desired, prior to calculating, the determined shift can be adjusted to enable the distance to be estimated with sub-pixel accuracy. Also, prior to correlating, the size of the edge images can be doubled.

The above steps can be performed by a software application including computer executable instructions executed by the processor of the image capture device. The software application may comprise routines, programs, object components, data structures etc. and be embodied as computer readable program code stored on a computer readable medium. The computer readable medium is any data storage device that can store data, which can thereafter be read by the processor of the image capture device. Examples of computer readable media include for example read-only memory, random-access memory, CD-ROMs, magnetic tape and optical data storage devices.

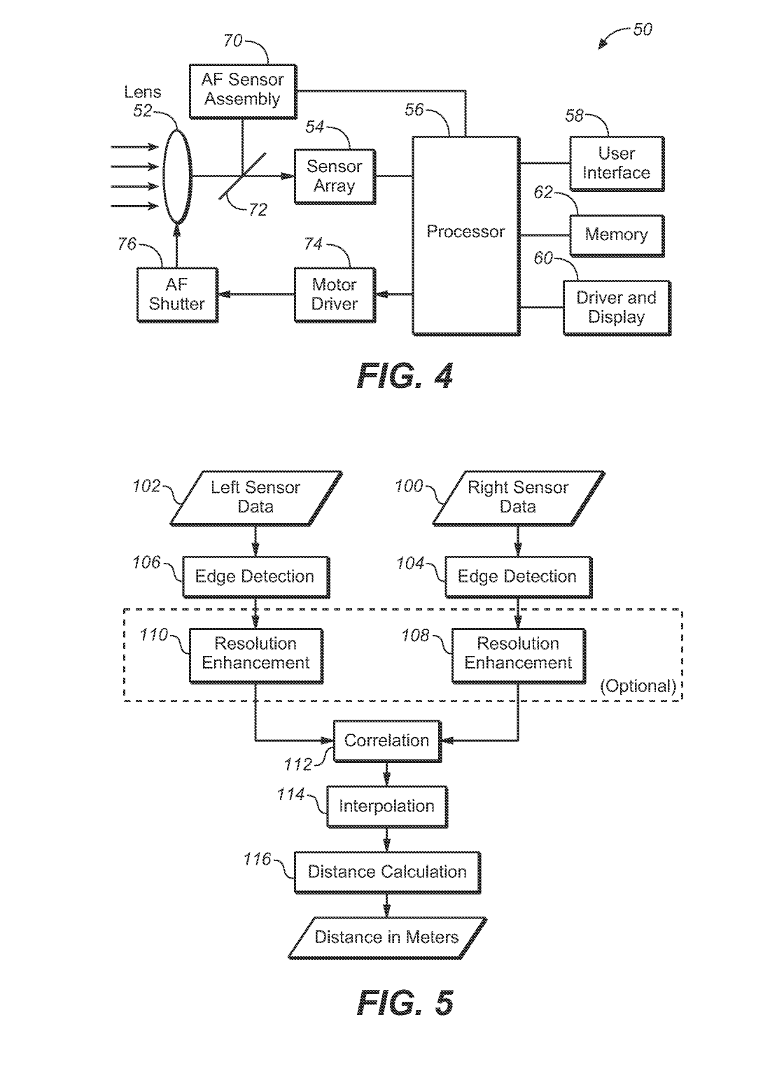

Turning now to FIG. 4, a simplified diagram of an image capture device in the form of a digital SLR camera is shown and is generally identified by reference numeral 50. Digital camera 50 comprises a lens assembly 52 that focuses incoming light onto a CCD or CMOS sensor array 54 when an image is to be captured. The sensor array 54 in turn provides raw image data to a processor 56. Processor 56 also communicates with a user interface 58 comprising control buttons, switches, rockers etc. that allow a user to operate the digital camera 50, a driver and associated display 60 and memory 62.

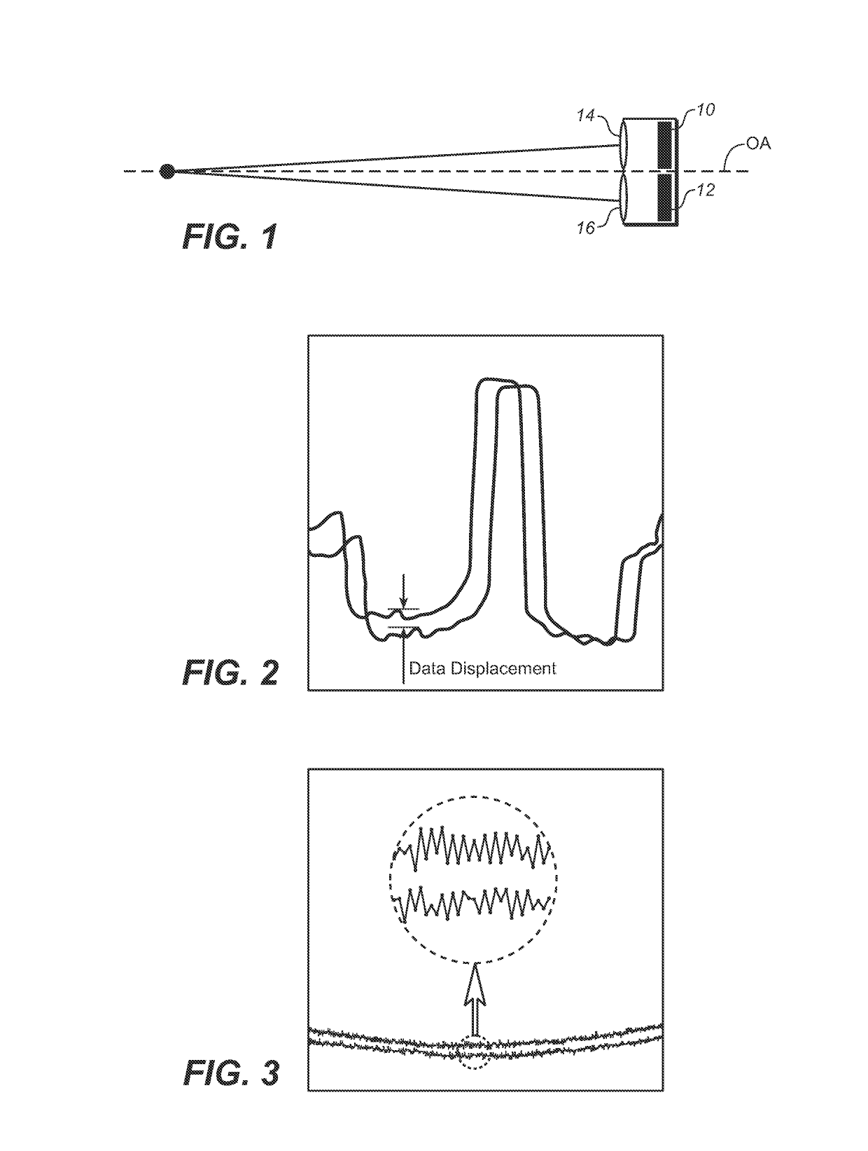

The digital camera 50 in this embodiment also includes a phase detection autofocus (AF) system comprising an AF sensor assembly 70. A mirror 72 reflects light entering the digital camera 50 via the lens assembly 52 towards the AF sensor assembly 70 when an image is not being captured. The AF sensor assembly 70 is similar to that shown in FIG. 1 and comprises right and left linear image sensors 10 and 12 and associated lenses 14 and 16. The image sensors 10 and 12 are angled slightly inwardly so that they look down the optical axis of the AF sensor assembly 70. Light directed to the AF sensor assembly 70 by the mirror 72 is divided into two paths and directed onto the right and left image sensors 10 and 12 via the associated lenses 14 and 16. The processor 56 communicates with the AF sensor assembly 70 and with a motor driver 74 and AF shutter 76 in a known manner thereby to provide the digital camera 50 with the autofocus feature.

In this embodiment, the digital camera 50 also uses the output of the AF sensor assembly 70 to estimate the distance to the subject in the field of view of the digital camera. To that end, the processor 56 executes a distance estimation application to allow the distance to the subject to be estimated. The steps performed during execution of the distance estimation application by the processor 56 will now be described with reference to FIG. 5.

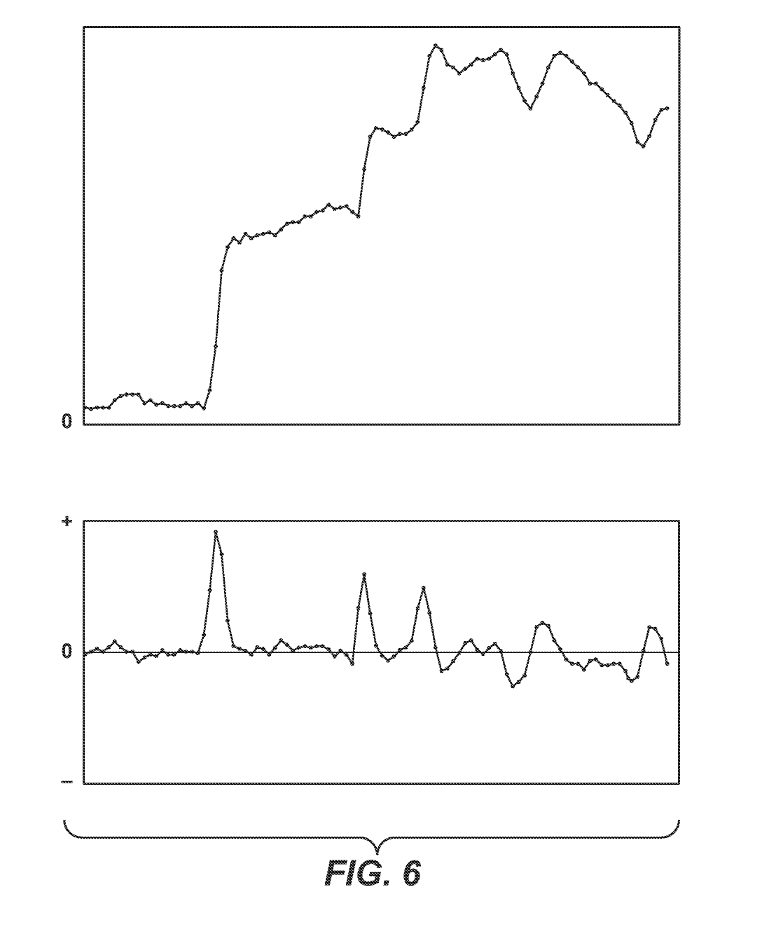

As can be seen in FIG. 5, during distance estimation, the raw images 100 and 102 acquired by the right image sensor 10 and the left image sensor 12 are initially subjected to edge detection to form corresponding right and left edge images (steps 104 and 106). During edge detection, for each raw image, the differences between pairs of pixels Nᵢ₊₁ and Nᵢ₋₁ in the raw image are determined and are used to represent the edge magnitudes of pixels Eᵢ in the corresponding edge image. FIG. 6 illustrates raw image data and corresponding edge data.

In this embodiment, once the right and left edge images have been generated, the edge images are subjected to doubling to enhance resolution (steps 108 and 110). Doubling the edge images assists in reducing interpolation error. During doubling of each edge image, for each edge image, an array that is twice as large as the edge image is created. The pixels Eᵢ of the edge image are then copied to the even locations of the array. Pixels Eᵢ at the odd locations of the array are calculated using cubic interpolation according to Equation (1) below:

Eᵢ=(−Eᵢ₋₃+9*Eᵢ₋₁+9*Eᵢ₊₁−Eᵢ₊₃)/16, where i=3,5,7, (1)

Since interpolated values cannot be calculated in the above manner for locations in the array that do not have the requisite consecutive neighbor locations, pixels Eᵢ are copied into these locations of the array in order to fill the voids. For example, in the case of a four-hundred (400) pixel edge image that is doubled, pixels Eᵢ are copied into the array as follows:

E₁=E₂; E₇₉₇=E₇₉₆; E₇₉₉=E₇₉₈.

Following right and left edge image doubling at steps 108 and 110, the doubled right and left edge images are correlated to determine the degree by which the doubled right edge image must be shifted to achieve the best fit with the doubled left edge image (step 112). A shift in the doubled right edge image where the sum of absolute differences between right and left edge image pixels is minimal, is considered optimal.

Once the optimal shift is determined, as the cross-correlation function can only be calculated at integral shift values, interpolation is carried out to generate a sub-pixel difference value that is added to the optimal shift (step 114). Following interpolation at step 114, a distance estimation to the subject in meters is calculated (step 116).

At step 112 during correlation, a correlation window CW is selected by the processor 56. For good light and contrast conditions, the size S_{CW} of the correlation window is chosen so that the angular size of the subject encompassed by the correlation window CW is in the range of from about 1.5 to about 4 degrees. In low-light and low-contrast conditions, the size of the correlation window may be chosen so that the angular size range of the subject is higher. The size S_{CW} of the correlation window CW in pixels is calculated according to Equation (2) below:

S_{CW}=[S_{CWD}*SA_{P}/SA_{Ø}]*2 (2)

where:

S_{CW} is the size of the correlation window CW in degrees;

SA_{P} is the size of the AF sensor assembly 70 in pixels; and

SA_{Ø} is the angle of view of the AF sensor assembly 70.

For example, in the case of a four-hundred (400) pixel AF sensor assembly having an angle of view equal to 10 degrees and assuming good light and contrast conditions, the correlation window CW is selected to have a size in the range of from above 60 to about 160 pixels depending on the number and intensity of edges in the region of interest centered around the subject.

With the size S_{CW} of the correlation window determined, the correlation window CW is placed on the doubled left edge image centered on the subject. A sliding correlation window S_{CW} of the same size is placed on the doubled right edge image. The sliding correlation window S_{CW} has a sliding range equal to −S_{CW}/2 to S_{CW}/2 about the center of the correlation window CW. Following this, the sliding correlation window SCW is placed at the left-most extent of its range and the cross-correlation XC(Δ) between pixels of the doubled right edge image within the sliding correlation window SCW and corresponding pixels of the doubled left edge image is calculated according to Equation (3) below:

$$XC ( Δ ) = {\sum }_{i = c - \frac{w - 1}{2}}^{c + \frac{w - 1}{2}} \vert L ( i ) - R ( i + Δ ) \vert \qquad ( 3 )$$

where:

c and w are the center and width of the correlation window CW;

R is the doubled right edge image;

L is the doubled right edge image; and

Δ is the shift between the doubled right and left edge images.

With the cross-correlation XC(Δ) calculated, the sliding correlation window SCW is shifted to the right by one pixel and the cross-correlation XC(Δ) is recalculated. This process is performed for each pixel shift of the sliding correlation window until the sliding correlation window SCW has reached the right-most extent of its range. At this stage, the calculated cross-correlations XC(Δ) are examined in order to determine the lowest cross-correlation XC(Δ)_{MIN}, which signifies the best match between the doubled right edge image and doubled left edge image. Correlating the right and left edge images is advantageous as the correlation is not dependent on data displacement due to the fact that the left and right raw image data is never directly compared. Also, the correlation results are not affected by parity noise due to the fact that even sensor elements are not compared with odd sensor elements.

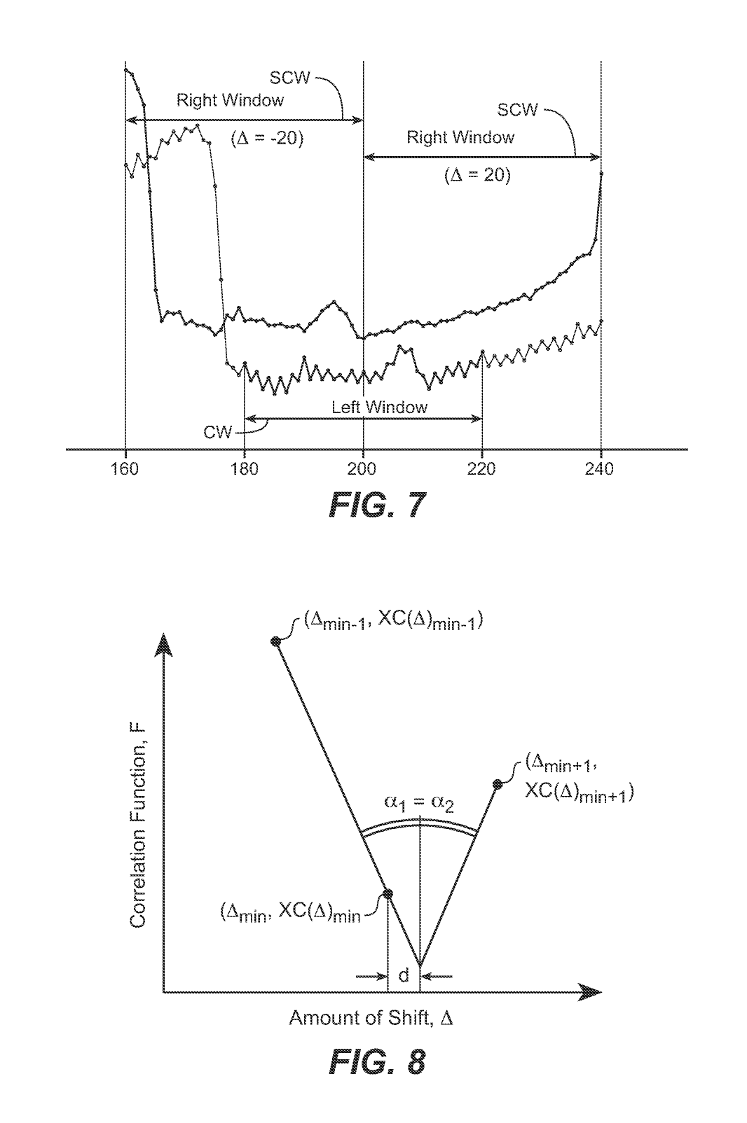

FIG. 7 shows an example of the correlation window CW on the doubled left edge image and the sliding correlation window SCW at the left-most and right-most extents of its range. In this example, the correlation window CW has a size S_{CW} equal to forty (40) pixels and is centered on pixel 200 of the doubled left edge image.

At step 114, during interpolation, a three-point interpolation involving the determined lowest cross-correlation XC(Δ)_{MIN} and the cross-correlations XC(Δ)_{MIN-1} and XC(Δ)_{MIN+1} calculated for the neighbor sliding correlation window shifts, is used to calculate a sub-pixel difference d according to Equation (4) below:

d=0.5−[(XC(Δ)_{MIN+1}−XC(Δ)_{MIN})/(2*(XC(Δ)_{MIN-1}−XC(Δ)_{MIN})] (4)

Following calculation of the sub-pixel difference d, the sub-pixel difference d is added to the shift Δ corresponding to the lowest cross-correlation XC(Δ)_{MIN}. The adjusted shift (Δ+d) is then used to calculate the distance to the subject.

At step 116, the distance D to the subject in meters is calculated according to Equation (5) below:

$$D = \frac{B}{{A}_{∞} - ( Δ + d )} \qquad ( 5 )$$

where:

A∞ is the shift for a subject at infinity; and

B is based on parameters of the AF sensor module 70, the focal length of the lens 52 and the pitch of the right and left image sensors 10 and 12.

As indicated in FIG. 5, doubling of the edge images is optional. Although edge image doubling improves accuracy, computational overhead is increased as the number of pixels requiring processing increases If the edge images are not doubled, the doubling factor in Equation (2) is removed.

Although particular embodiments have been described, those of skill in the art will appreciate that variations and modifications may be made without departing from the spirit and scope thereof as defined by the appended claims.

What is claimed is:

1. A method of estimating the distance to a subject using image signals generated by autofocus image sensors of an image capture device, said method comprising:
processing image data of each image sensor to detect edges therein and for each image sensor generating a corresponding edge image;
correlating the edge images to determine the shift of one edge image relative to the other edge image that yields the best match therebetween; and
calculating a distance estimation based at least on the determined shift.

2. The method of claim 1 further comprising, prior to said calculating, adjusting said determined shift.

3. The method of claim 2 wherein the determined shift is adjusted based on correlation data generated during said correlating to enable the distance estimation to be calculated to sub-pixel accuracy.

4. The method of claim 3, wherein said adjusting comprises adding a difference value to said determined shift.

5. The method of claim 4 wherein said difference value is calculated via interpolation of correlation data generated during said correlating.

6. The method of claim 1 wherein said correlating comprises:
comparing said one edge image with said other edge image and generating a cross-correlation value;
shifting said one edge image relative to said other edge image and generating another cross-correlation value;
repeating the shifting and cross-correlation value generating;
determining the smallest cross-correlation value; and
selecting the shift position associated with the smallest cross-correlation value as the determined shift.

7. The method of claim 6 wherein said shifting and cross-correlation value generating is performed over a range centered about the subject.

8. The method of claim 7 wherein during said comparing, a subset of pixels of said one edge image is compared with corresponding pixels of said other edge image.

9. The method of claim 8 wherein said subset has a size selected at least to encompass the entirety of said subject.

10. The method of claim 1 further comprising, prior to said correlating, doubling the size of said edge images.

11. The method of claim 10 wherein said correlating comprises:
comparing said one edge image with said other edge image and generating a cross-correlation value;
shifting said one edge image relative to said other edge image and generating another cross-correlation value;
repeating the shifting and cross-correlation value generating;
determining the smallest cross-correlation value; and
selecting the shift position associated with the smallest cross-correlation value as the determined shift.

12. The method of claim 11 wherein said shifting and cross-correlation value generating is performed over a range centered about the subject.

13. The method of claim 12 wherein during said comparing, a subset of pixels of said one edge image is compared with corresponding pixels of said other edge image, said subset being of a size selected to encompass at least the entirety of said subject.

14. The method of claim 11 wherein the determined shift is adjusted based on correlation data generated during said correlating to enable the distance estimation to be calculated to sub-pixel accuracy.

15. The method of claim 14, wherein said adjusting comprises adding a difference value to said determined shift that is calculated via interpolation of cross-correlation values.

16. The method of claim 1 wherein said distance estimation calculating is based on said determined shift and at least one parameter of said image capture device.

17. An apparatus for estimating the distance to a subject using image signals generated by autofocus image sensors of an image capture device, said apparatus comprising:
processing structure communicating with said image sensors, said processing structure processing image data of each image sensor to detect edges therein and for each image sensor generating a corresponding edge image, correlating the edge images to determine the shift of one edge image relative to the other edge image that yields the best match therebetween and calculating a distance estimation based on the determined shift and at least one parameter of said image capture device.

18. An apparatus according to claim 17 embodied in said image capture device.

19. An apparatus according to claim 18 wherein said image capture device is one of a digital camera, a video recorder and a scanner.

20. A computer readable medium embodying a computer program for estimating the distance to a subject using image signals generated by autofocus image sensors of an image capture device, said computer program comprising:
computer program code for processing image data of each image sensor to detect edges therein and for each image sensor generating a corresponding edge image;
computer program code for correlating the edge images to determine the shift of one edge image relative to the other edge image that yields the best match therebetween; and
computer program code for calculating a distance estimation based at least on the determined shift.
